(19) United States
(12) Patent Application Publication
(10) Pub. No.: US 2013/0309106 A1
(43) Pub. Date: Nov. 21, 2013

(54) TURBOCHARGER

(71) Applicant: DENSO CORPORATION, Kariya-city (JP)

(72) Inventor: Etsugo YANAGIDA, Chiryu-city (JP)

(73) Assignee: DENSO CORPORATION, Kariya-city (JP)

(21) Appl. No.: 13/897,819

(22) Filed: May 20, 2013

(30) Foreign Application Priority Data
May 21, 2012 (JP) 2012-115943

(51) Int. Cl. F02B 37/18

(52) U.S. Cl. CPC F02B 37/183
USPC 417/406

(57) ABSTRACT

A turbocharger includes a first bypass opening which introduces an exhaust gas from a first exhaust scroll to a downstream area downstream of the turbine impeller, and a second bypass opening which introduces the exhaust gas from a second exhaust scroll to the downstream area. The turbocharger further includes a waste gate valve opens and closes both the first bypass opening and the second bypass opening at the same time. Thus, the waste gate valve can function even though the switch valve is completely closed. Since the exhaust gas is introduced toward the downstream area via both the first bypass opening and the second bypass opening, a pressure loss is restricted and an exhaust pressure of the exhaust gas can be restricted. Further, a turbine efficiency can be improved.

### CROSS-REFERENCE TO RELATED APPLICATION

This application is based on Japanese Patent Application No. 2012-115943 filed on May 21, 2012, the disclosure of which is incorporated herein by reference.

### TECHNICAL FIELD

The present disclosure relates to a turbocharger which can change its volume by a first exhaust scroll and a second exhaust scroll. The first exhaust scroll and the second exhaust scroll swirl an exhaust gas and then introduce the exhaust gas toward a turbine impeller. Particularly, the present disclosure relates to a bypassing technology of the exhaust gas.

### BACKGROUND

JP-S62-251422A describes a turbocharger using a conventional technology with reference to FIG. 6. The same parts and components as those in embodiments of the present disclosure, which will be described later, are indicated with the same reference numerals.

The turbocharger includes a first exhaust scroll 7, a second exhaust scroll 8, a switch opening 9, and a switch valve 10. The switch opening 9 introduces an exhaust gas from the first exhaust scroll 7 to the second exhaust scroll 8. The switch valve 10 opens or closes the switch opening 9.

When the switch valve 10 closes the switch opening 9, a small flow state is achieved. In the small flow state, the exhaust gas is introduced from the first exhaust scroll 7 to a turbine impeller, so a quantity of the exhaust gas is small.

When the switch valve 10 opens the switch opening 9, a large flow state is achieved. In the large flow state, the exhaust gas is introduced from both the first exhaust scroll 7 and the second exhaust scroll 8 to the turbine impeller, so the quantity of the exhaust gas is large.

The turbocharger further includes a waste gate valve 11 and a bypass opening 13.

The bypass opening 13 introduces the exhaust gas from the second exhaust scroll 8 to a downstream area a which is defined downstream of the turbine impeller. The bypass opening 13 may be replaced by a passage or an aperture. The waste gate valve 11 opens or closes the bypass opening 13.

In the large flow state, when a flow rate of the exhaust gas is increased, the waste gate valve 11 adjusts an exhaust pressure of the exhaust gas supplied to the turbine impeller by opening the bypass opening 13.

When the switch valve 10 is completely closed, the exhaust gas is not introduced to the second exhaust scroll 8. Thus, the waste gate valve 11 cannot function.

When the switch valve 10 is opened, a pressure loss of the exhaust gas is increased because the exhaust gas which bypasses the turbine impeller flows through the switch valve 10. Thus, an exhaust pressure of the exhaust gas upstream of the turbine impeller may be increased even though the waste gate valve 11 is opened.

### SUMMARY

The present disclosure is made in view of the above matters, and it is an object of the present disclosure to provide a turbocharger in which a waste gate valve can function even though a switch valve is completely closed, and a pressure loss of an exhaust gas which bypasses a turbine impeller by the waste gate valve can be restricted.

According to an aspect of the present disclosure, even though the switch valve is completely closed, the exhaust gas can be introduced to a turbine downstream area by opening the waste gate valve. That is, the waste gate valve can function even though the switch valve is completely closed.

Since the waste gate valve is opened, the exhaust gas flows though both a first bypass opening and a second bypass opening. Thus, the pressure loss of the exhaust gas which bypasses the turbine impeller by the waste gate valve can be restricted, and an exhaust pressure of the exhaust gas upstream of the turbine impeller can be restricted.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a cross-sectional view taken along a line I-I of a turbocharger in FIG. 4, according to an embodiment of the present disclosure;

FIG. 2 is a cross-sectional view taken along a direction of an arrow II in FIG. 4, according to the embodiment;

FIG. 3 is a cross-sectional view taken along a line III-III of a part of the turbocharger in FIG. 4, according to the embodiment;

FIG. 4 is a graph showing an outline of the turbocharger according to the embodiment;

FIGS. 5A and 5B are block diagrams showing a switch valve and a waste gate valve in different ways, according to the embodiment; and

FIG. 6 is a cross-sectional view showing a part of a turbocharger according to a conventional example.

### DETAILED DESCRIPTION

Hereafter, embodiments of the present disclosure will be described. The same parts and components as those in each embodiment are indicated with the same reference numerals and the same descriptions will not be reiterated.

Referring to the drawings, an embodiment of the present disclosure will be described hereinafter.

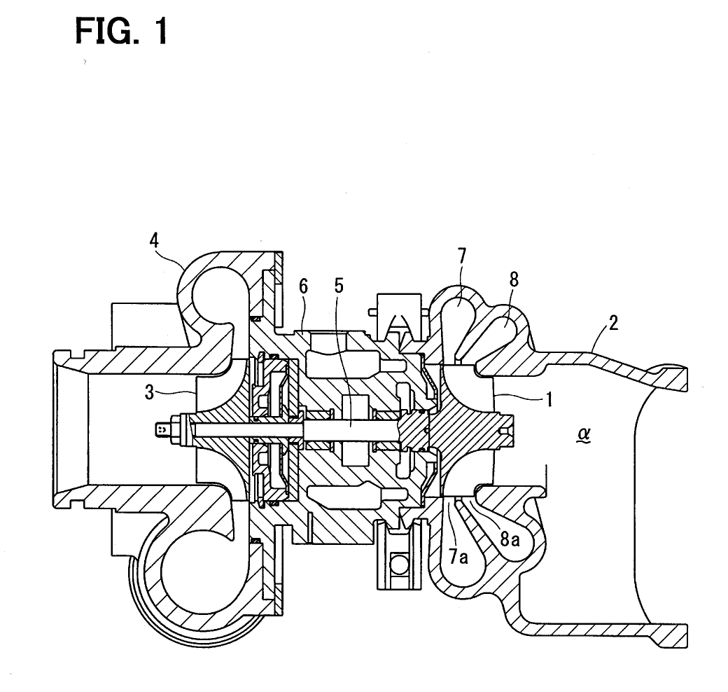

A turbocharger supercharges an intake gas which is supplied by an internal combustion engine. As shown in FIG. 1, the turbocharger includes a turbine impeller 1, a turbine housing 2, a compressor impeller 3, a compressor housing 4, a shaft 5, and a center housing 6. Hereinafter the internal combustion engine is referred to as an engine.

The turbine housing 2 includes a first exhaust scroll 7 and a second exhaust scroll 8 which introduce an exhaust gas of the engine toward the turbine impeller 1.

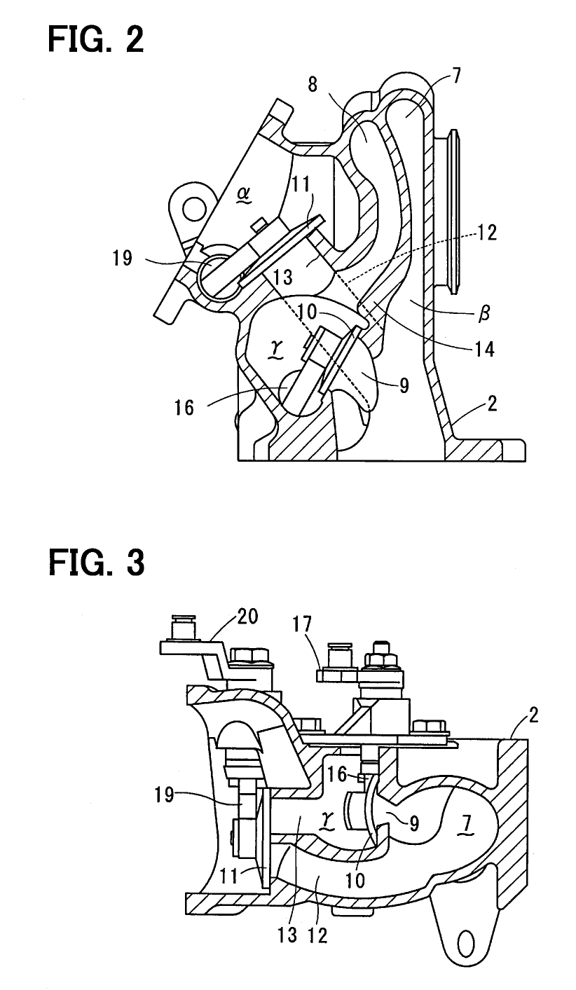

The turbocharger further includes a switch valve 10 and a waste gate valve 11, as shown in FIGS. 2 and 3.

The switch valve 10 adjusts an opening degree of a switch opening 9 which introduces the exhaust gas from the first exhaust scroll 7 to the second exhaust scroll 8. The switch opening 9 may be replaced by a passage or an aperture. Hereinafter, each type of openings may be replaced by a passage or an aperture.

The waste gate valve 11 introduces the exhaust gas upstream of the turbine impeller 1 to a downstream area a downstream of the turbine impeller 1. That is, the exhaust gas bypasses the turbine impeller 1.

The waste gate valve 11 opens or closes both a first bypass opening 12 and a second bypass opening 13.

The first bypass opening 12 is for introducing the exhaust gas from the first exhaust scroll 7 to the downstream area α.

The second bypass opening 13 is for introducing the exhaust gas from the second exhaust scroll 8 to the downstream area α.

Hereafter, an embodiment apply to the present disclosure will be described more specifically with reference to the drawings. The present disclosure is not limited to the embodiment.

In the embodiment, the same parts and components as those in the conventional example are indicated with the same reference numerals.

The turbocharger is attached to the engine for a vehicle to travel. The engine may be an internal combustion engine which generates a rotational power by a combustion of fuel, such as a gasoline engine or a diesel engine.

The turbocharger may be a supercharger which compresses the intake gas by an energy of the exhaust gas from the engine.

As shown in FIG. 1, the turbocharger includes the turbine impeller 1, the turbine housing 2, the compressor impeller 3, the compressor housing 4, the shaft 5, and the center housing 6.

The turbine impeller 1 is driven to rotate by the exhaust gas from the engine. The turbine housing 2 is whorl-shaped, and accommodates the turbine impeller 1. The compressor impeller 3 is driven by a rotational force of the turbine impeller 1 to compress the intake gas. The compressor housing 4 is whorl-shaped, and accommodates the compressor impeller 3. The shaft 5 transmits a rotation of the turbine impeller 1 to the compressor impeller 3. The center housing 6 supports the shaft 5 so that the shaft 5 can be rotated freely in a high speed.

In the turbocharger, the turbine housing 2, the compressor housing 4, and the center housing 6 are connected with each other in an axis direction by fastener such as V band, snip ring, or bolt.

The first exhaust scroll 7 includes a first exhaust outlet 7a which is ring-shaped and provided at a distal portion. The first exhaust scroll 7 rotates the exhaust gas from the engine, and introduces the exhaust gas toward an exhaust upstream portion of the turbine impeller 1. The exhaust upstream portion is provided at a position of the turbine housing 2 close to the center housing 6.

The second exhaust scroll 8 includes a second exhaust outlet 8a which is ring-shaped and provided at a distal portion. The second exhaust scroll 8 rotates a part of the exhaust gas introduce to the first exhaust scroll 7 in the same direction, and introduces the exhaust gas toward a center portion of the turbine impeller 1. The center portion is provided at a position of the turbine housing 2 opposite to the center housing 6 with respect to the first exhaust outlet 7a.

The exhaust upstream portion of the first exhaust scroll 7 always communicates with an exhaust inlet of the turbine housing 2 so that the exhaust gas is always supplied to the first exhaust scroll 7. The exhaust inlet may correspond to a connection opening to an exhaust manifold.

The exhaust upstream portion of the second exhaust scroll 8 communicates with the first exhaust scroll 7 via the switch opening 9. The switch opening 9 is opened or closed by the switch valve 10.

Specifically, referring to FIG. 2, the turbine housing 2 has an isolate wall 14 provided between the first exhaust scroll 7 and the second exhaust scroll 8. Further, in the turbine housing 2, a throttle portion β is defined by the isolate wall 14 at a position of the first exhaust scroll 7 so that a flow passage area for introducing the exhaust gas can be throttled.

The switch opening 9 is defined at a position of the isolate wall 14 upstream of the throttle portion β. That is, the switch opening 9 is defined at a position of the first exhaust scroll 7 where the flow passage area is large.

Since the switch valve 10 adjusts the opening degree of the switch opening 9, the exhaust gas supplied to the second exhaust scroll 8 is controlled.

Specifically, when the switch valve 10 closes the switch opening 9, a small flow state is achieved. In the small flow state, the exhaust gas flows from the first exhaust scroll 7 to the turbine impeller 1, so a quantity of the exhaust gas is small.

When the switch valve 10 opens the switch opening 9, a large flow state is achieved. In the large flow state, the exhaust gas flows from both the first exhaust scroll 7 and the second exhaust scroll 8 to the turbine impeller 1, so the quantity of the exhaust gas is large.

In the turbine housing 2, the waste gate valve 11 is provided so as to introduce the exhaust gas upstream of the turbine impeller 1 to the downstream area α. That is, the exhaust gas bypasses the turbine impeller 1.

The first bypass opening 12 and the second bypass opening 13 are provided in the turbine housing 2 as shown in FIGS. 2 and 3.

An upstream end portion of the first bypass opening 12 which is a connection opening of the first exhaust scroll 7 is defined at a position of the first exhaust scroll 7 upstream of the throttle portion β. That is, the upstream end portion of the first bypass opening 12 as well as the switch opening 9 is defined at a position of the first exhaust scroll 7 where the flow passage area is large.

An upstream end portion of the second exhaust scroll 8 includes a movable space γ in which the switch valve 10 can open or close freely. In the movable space γ, the switch valve 10 is moved in a predetermined range.

An upstream end portion of the second bypass opening 13 which is a connection opening of the second exhaust scroll 8 is defined at a position adjacent to the movable space y. That is, the upstream end portion of the second bypass opening 13 is defined at a position of the second exhaust scroll 8 where the flow passage area is large.

As shown in FIG. 3, a downstream end portion of the first bypass opening 12 and a downstream end portion of the second bypass opening 13 are defined to be adjacent to each other, so that both of them are opened or closed by the single waste gate valve 11 at the same time.

Since the waste gate valve 11 adjusts the opening degrees of both the first bypass opening 12 and the second bypass opening 13, the exhaust gas supplied to both the first exhaust scroll 7 and the second exhaust scroll 8 is controlled.

Specifically, when the quantity of the exhaust gas per unit time period is excessive such as a case where the engine is rotated in a high speed, the waste gate valve 11 is opened such that the exhaust gas upstream of both the first exhaust scroll 7 and the second exhaust scroll 8 is introduced to the downstream area α.

Thus, an exhaust pressure of the exhaust gas supplied to the turbine impeller 1 is prevented from increasing excessively, and a turbine efficiency can be improved.

The switch valve 10 and the waste gate valve 11 may be driven by an actuator 15 which is independent.

Alternatively, the switch valve 10 and the waste gate valve 11 may be driven by a single actuator and a link mechanism. The link mechanism may adjust the opening degree of the switch valve 10 and the opening degree of the waste gate valve 11 separately to change a moving characteristic.

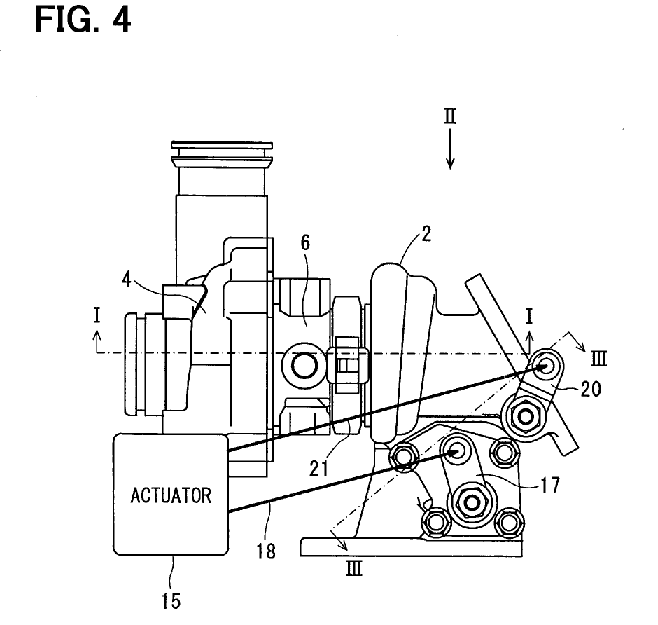

Referring to FIG. 4, it is preferable that the actuator 15 is attached to a member apart from the turbine housing 2 in thermal. The actuator 15 may be an electromagnetic actuator which is a combination of an electric motor and a reducer, and the member may be the compressor housing 4.

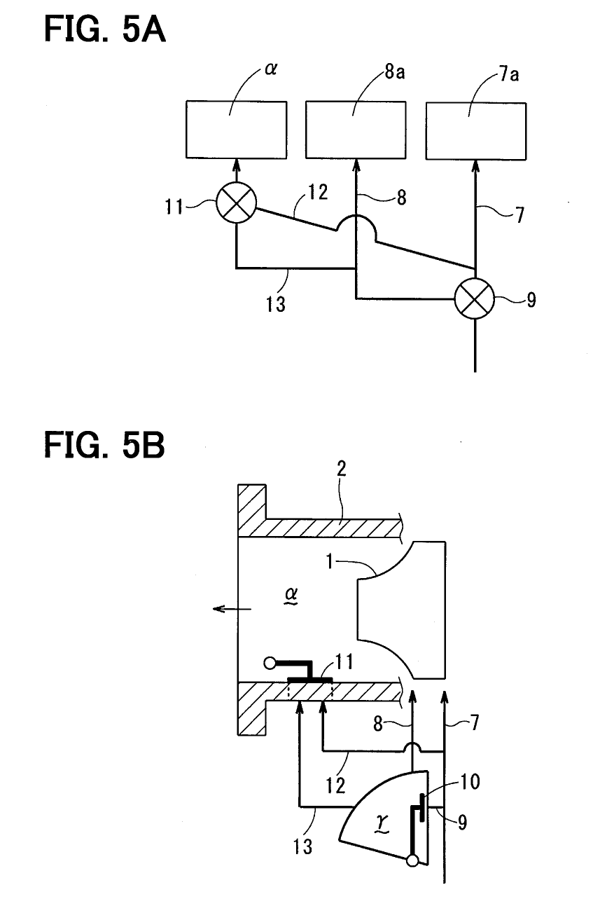

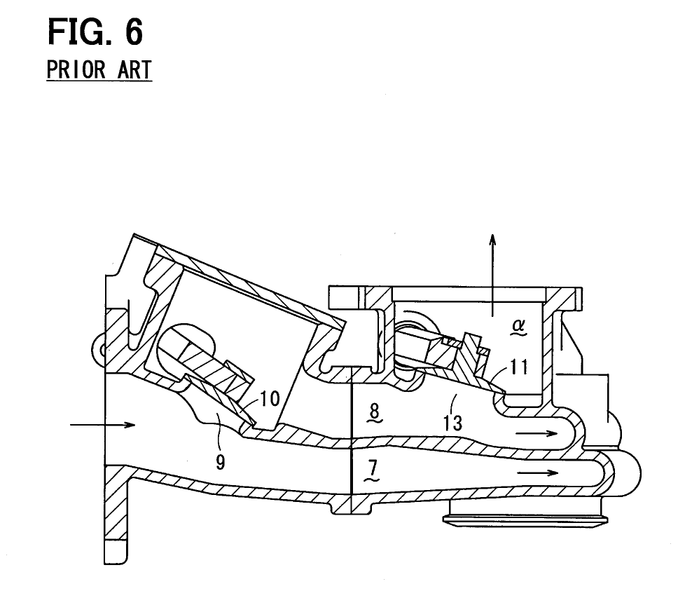

FIGS. 5A and 5B are block diagrams for the embodiment to be readily understood.

As shown in FIGS. 5A and 5B, an example of the switch valve 10 and the waste gate valve 11 will be described.

The switch valve 10 may be a poppet valve which is used to open or close the switch opening 9. The poppet valve is an umbrella-shaped valve that rises perpendicularly from its seat. The switch valve 10 is moved from an external of the turbine housing 2 via a switch shaft 16. The switch shaft 16 is supported by the turbine housing 2 to move freely in the turbine housing 2.

Specifically, a switch arm 17 is connected with a distal end of the switch shaft 16 which is placed outside of the turbine housing 2. A distal end of the switch arm 17 is connected with a rod 18 which is driven by the actuator 15. Therefore, the switch valve 10 is moved by the actuator 15.

The waste gate valve 11 may also use the same configuration as the switch valve 10.

The waste gate valve 11 may be a poppet valve which is used to open or close both the first bypass opening 12 and the second bypass opening 13. The waste gate valve 11 is moved from the external of the turbine housing 2 via a waist shaft 19. The waist shaft 19 is supported by the turbine housing 2 to move freely in the turbine housing 2.

Specifically, a waste gate arm 20 is connected with a distal end of the waist shaft 19 which is placed outside of the turbine housing 2. A distal end of the waste gate arm 20 is connected with a waste gate rod 21 which is driven by the actuator 15. Therefore, the waste gate valve 11 is moved by the actuator 15.

The actuator 15 is controlled by an engine control unit (ECU) which is not shown.

The ECU computes a target intake quantity based on an operation state of the engine such as an engine speed or an accelerator position. The ECU computes a target supercharge-pressure based on the target intake quantity. The ECU computes the opening degree of the switch valve 10 based on a relationship between the target supercharge-pressure and the operation state. The ECU controls the switch valve 10 so that a target degree of the switch valve 10 can be obtained.

The ECU controls the waste gate valve 11 so that an intake pressure of the intake gas compressed by the compressor impeller 3 is smaller than or equal to a first predetermined pressure. The intake pressure may be detected by a supercharge-pressure sensor. Alternatively, the ECU controls the waste gate valve 11 so that the exhaust pressure is smaller than or equal to a second predetermined pressure. The exhaust pressure may be detected by a turbine exhaust pressure sensor, or may be acquired by computing. In addition, the ECU controls the waste gate valve 11 priority of the switch valve 10.

According to the present embodiment, the following advantage may be obtained.

(1) The turbocharger can introduce the exhaust gas toward the downstream area a via the first bypass opening 12 because the waste gate valve 11 is opened, even when the switch valve 10 is completely closed.

Thus, the waste gate valve 11 can function even though the switch valve 10 is completely closed.

(2) The turbocharger can introduce the exhaust gas toward the downstream area a via both the first bypass opening 12 and the second bypass opening 13, because the waste gate valve 11 is opened. Thus, a pressure loss of the waste gate valve 11 can be restricted.

Even in a case where the quantity of the exhaust gas per unit time period is excessive, the exhaust pressure can be decreased, and the turbine efficiency can be improved.

(3) In a case where the first bypass opening 12 is defined at a position of the first exhaust scroll 7 downstream of the throttle portion β, a pressure loss of the first bypass opening 12 may become large. In addition, at the position downstream of the throttle portion β, the flow passage area is small, that is, the passage is narrow. Since the quantity of the exhaust gas flowing through the first bypass opening 12 is small, an effect of decreasing the exhaust pressure by the first bypass opening 12 is deteriorated.

Meanwhile, according to the present embodiment, the first bypass opening 12 is defined at a position of the first exhaust scroll 7 upstream of the throttle portion β. That is, the first bypass opening 12 is defined at a position of the first exhaust scroll 7 where the flow passage area is large. Thus, the pressure loss of the first bypass opening 12 can be restricted, and a large quantity of the exhaust gas can be introduced toward the downstream area α via the first bypass opening 12. Therefore, the exhaust pressure can be decreased.

(4) In a case where the second bypass opening 13 is defined at a position of the second exhaust scroll 8 except the movable space γ, a pressure loss of the second bypass opening 13 may become large. Since the quantity of the exhaust gas flowing through the second bypass opening 13 is small, an effect of decreasing the exhaust pressure by the second bypass opening 13 is deteriorated.

Meanwhile, according to the present embodiment, the second bypass opening 13 is defined at a position in the movable space γ. That is, the first bypass opening 12 is defined at a position of the first exhaust scroll 7 where the flow passage area is large. Thus, the pressure loss of the first bypass opening 12 can be restricted, and a large quantity of the exhaust gas can be introduced toward the downstream area α via the first bypass opening 12. Therefore, the exhaust pressure can be decreased.

As the above description, the pressure loss of the first bypass opening 12 and the pressure loss of the second bypass opening 13 can be restricted.

Thus, a large quantity of the exhaust gas can be introduced toward the downstream area a via both the first bypass opening 12 and the second bypass opening 13 because the waste gate valve 11 is opened. Even in a case where the quantity of the exhaust gas per time period is excessive, the exhaust pressure can be decreased, and the turbine efficiency can be improved.

According to the present embodiment, the actuator 15 is not limited to the electrical actuator. The actuator 15 may be other actuators which can be controlled by the ECU. For example, an oil pressure actuator or a negative pressure actuator.

What is claimed is:

1. A turbocharger comprising:
a turbine impeller driving a compressor impeller to compress an intake gas;
a first exhaust scroll swirling an exhaust gas emitted from an engine and introducing the exhaust gas to the turbine impeller;
a second exhaust scroll provided independently from the first exhaust scroll, the second exhaust scroll swirling the exhaust gas emitted from the engine and introducing the exhaust gas to the turbine impeller;
a switch valve adjusting an opening degree of a switch opening which introduces the exhaust gas from the first exhaust scroll to the second exhaust scroll; and
a waste gate valve making the exhaust gas bypass the turbine impeller in order to introduce the exhaust gas upstream of the turbine impeller to a downstream area downstream of the turbine impeller, wherein
the waste gate valve opens and closes both a first bypass opening and a second bypass opening at the same time,
the first bypass opening is for introducing the exhaust gas from the first exhaust scroll to the downstream area, and
the second bypass opening is for introducing the exhaust gas from the second exhaust scroll to the downstream area.

2. A turbocharger according to claim 1, further comprising:
a throttle portion throttling a flow passage area upstream of the first exhaust scroll, wherein
the first bypass opening is defined at a position of the first exhaust scroll upstream of the throttle portion.

3. A turbocharger according to claim 1, wherein
the second bypass opening is defined at a position of the second exhaust scroll adjacent to a movable space where the switch valve moves.
